(19) United States
(12) Patent Application Publication
(10) Pub. No.: US 2007/0032944 A1
(43) Pub. Date: Feb. 8, 2007

(54) Display device for car navigation system

(75) Inventor: Yoshikazu Inagaki, Novi, MI (US)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/498,251

(22) Filed: Aug. 3, 2006

(30) Foreign Application Priority Data
Aug. 5, 2005 (JP) 2005-228148

(51) Int. Cl. G01C 21/00

(52) U.S. Cl. 701/200; 340/995.1

(57) ABSTRACT

A display device including a touch panel integrally formed with a display panel such as a liquid crystal display panel is advantageously used in a car navigation system. A ball is displayed together with other information on the display panel. The ball is adapted to be rotated by touching it for scrolling the displayed information or moving a highlighted item on a displayed list. When a desired item is highlighted, that item can be selected by simply pushing the ball to thereby input a command corresponding to the selected item to the system. A navigation map displayed on the display panel may be scrolled or its scale may be changed by rotating the ball. In this manner, a driver can easily and conveniently input a command to the system.

### CROSS-REFERENCE TO RELATED APPLICATION

This application is based upon and claims benefit of priority of Japanese Patent Application No. 2005-228148 filed on Aug. 5, 2005, the content of which is incorporated herein by reference.

### BACKGROUND OF THE INVENTION

1. Field of the Invention

The present invention relates to a display device for a car navigation system.

2. Description of Related Art

A touch panel integrally formed with a display panel is widely used in a car navigation system. A user can easily input commands by touching buttons displayed on the touch panel without operating a remote controller or using a cursor on the display panel. On the other hand, it is difficult for the user to have concrete physical feeling in inputting commands because he/she only touches the touch panel without pushing buttons or the like. When the commands are inputted through a remote controller, joystick or rotary dial, the user is able to obtain a concrete physical feeling in inputting commands. Therefore, in the case of a touch panel, the user has to be careful not to input a wrong command in error.

In an “i-pod” (a registered trademark of Apple) for playing music, a doughnut-shaped touch panel which is separate from a display panel is used for inputting commands. A user sidably touches the doughnut-shaped touch panel along a circular path to scroll a display displayed on the display panel. In this touch panel, a user is able to easily input commands while avoiding erroneous inputs by restricting a touch direction on the touch panel. However, if the doughnut-shaped touch panel is applied to a car navigation system, its functions to be performed by inputting commands have to be restricted due to limited manipulation freedom of the touch panel. Further, it would be difficult for the user (driver) to accurately move his/her touch on the touch panel along a circular path, because the display panel is usually located at a slanted front of the user in the case of the car navigation system.

On the other hand, JP-A-2004-185562 proposes a display panel for listing candidate items to be selected by a user. In this display panel, a cursor on the display returns to its previous position if the cursor does not move out of a predetermined area within a predetermined time period. In this manner, unintended movement of the cursor due to vibration of a motor vehicle can be avoided. However, user's freedom in handling cursor has to be restricted, thereby sacrificing his/her feeling in manipulating the cursor.

### SUMMARY OF THE INVENTION

The present invention has been made in view of the above-mentioned problem, and an object of the present invention is to provide an improved display device for a car navigation system, in which a user can easily and conveniently use a display panel of the display device. Another object of the present invention is to provide an interface technology between the user and the device.

The display device of the present invention is advantageously applicable to a car navigation system. The display device includes a display panel such as a color liquid crystal display panel, a touch panel for inputting commands or for selecting items, and a controller for controlling operation of the display device. The touch panel is integrally formed with the display panel that is installed at a place in front of a driver.

A ball is displayed on the display panel together with other information displayed thereon. The ball may be displayed in an exclusive region or in an overlapped manner with the other information. The ball is adapted to be rotated by touching it. When a user touches the displayed ball, his/her finger (or a touching stick or the like) slides thereon in a desired direction and a desired length. The ball rotates by an amount and in a direction according to the touch of the user. According to rotation of the ball, information items displayed on the display panel are scrolled, or a position of a highlighted item moves. When a desired item is highlighted, the user simply pushes the ball to thereby select the item or input a command corresponding to the item. The controller performs a function corresponding to the selected item.

The position of the ball displayed on the display panel may be selected by user's preference, i.e., it may be displayed in the exclusive region or in an overlapped manner with other information displayed. A speaker may be used for outputting sounds representing a rotational direction of the ball and/or its rotational speed. The rotational directions of the ball may be preset, so that the ball rotates in predetermined directions even if a sliding direction of a touching finger is not exact. A pointer which moves according to rotation of the ball may be displayed on the display panel. A navigation map displayed on the display panel may be scrolled by rotating the ball, or its scale may be changed by rotating the ball.

According to the present invention, items displayed on the display panel are easily selected by rotating the ball that is also displayed on the same panel. A driver is able to easily and conveniently input commands to the navigation system. Other objects and features of the present invention will become more readily apparent from a better understanding of the preferred embodiment described below with reference to the following drawings.

### BRIEF DESCRIPTION OF THE DRAWINGS

FIG. 1 is a block diagram showing an entire structure of a car navigation system;

FIG. 2 is an example of a display displayed on a display panel;

FIG. 3 is a flowchart showing a process for selecting items shown on a display panel by touching a touch panel; and

FIG. 4 is another example of a display displayed on a display panel.

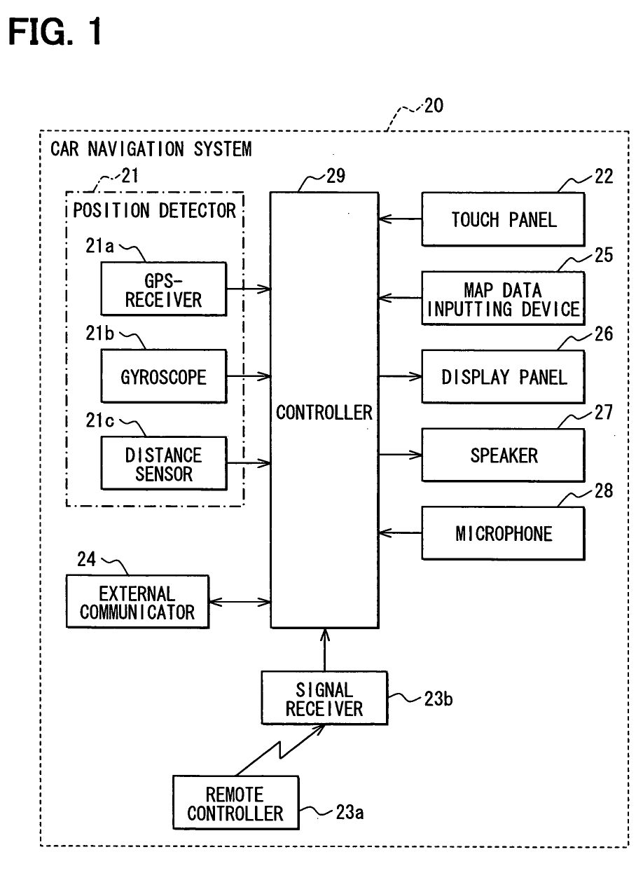

### DETAILED DESCRIPTION OF THE PREFERRED EMBODIMENT

A preferred embodiment of the present invention will be described with reference to accompanying drawings. A car navigation system 20 is mounted on an automotive vehicle. The car navigation system 20 includes a position detector 21, a touch panel 22 for inputting commands, a remote controller 23a for wirelessly inputting commands, a signal receiver 23b for receiving wireless signals from the remote controller 23a, an external communicator 24 for communicating with external networks such as a packet communication network, a map data inputting device 25 for inputting map data memorized in memory media into the car navigation system 20, a display panel 26, a speaker 27 for outputting sound information, a microphone 28 for inputting voice commands or the like, and a controller 29.

The controller 29 carries out various programs according to inputs from the position detector 21, the touch panel 22, the remote control signal receiver 23b, the external communicator 24, the map date inputting device 25 and the microphone 28. The controller 29 also controls operation of the external communicator 24, the display panel 26, and the speaker 27.

The position detector 21 includes a GPS-receiver 21a for receiving signals from satellites of a Global Positioning System (GPS) through a GPS antenna (not shown), a gyroscope 21b for detecting rotational motion of a vehicle, and a distance sensor 21c for detecting a driven distance based on acceleration of the vehicle. The controller 29 calculates a position of the vehicle, a driving direction, a driving speed, etc. based on outputs from the GPS-receiver 21a, the gyroscope 21b and the distance sensor 21c. A present position of the vehicle may be calculated by various methods, such as a single direction-measurement method or a relative direction-measurement method.

The touch panel 22 is formed integrally with the display panel 26. The touch panel 22 outputs a coordinate of a position touched by a user. The coordinate of the touched position may be detected by various methods, such as a pressure-sensing method, an electromagnetic induction method, a static capacitance method or a combination thereof. The external communicator 24 receives information regarding traffic accidents and traffic jams from a VICS information center through an optical beacon or an electromagnetic wave beacon. Various data stored in memory media such as a hard disc and a DVD-ROM are inputted through the map data inputting device 25. The data stored in the memory media include map data (such as node data, link data, cost data, background data, road data, name data, mark data, intersection data and facility data), voice data for guiding a driver, data for recognizing inputted voices. These data may be fed to the car navigation system 20 through a communication network in place of the memory media.

The display panel 26 is a color display panel that may be constituted by various devices, such as a liquid crystal display panel, an organic electroluminescence display panel or a cathode ray tube. On the display panel 26, a map inputted from the map data inputting device 25 is shown. A present position of the vehicle detected by the position detector 21, a driving route to a destination, landmarks, facility names and other information can be shown on the display panel, overlapped on the map. Further, information and guidance of facilities may be displayed. The speaker 27 outputs voice guidance for facilities and the driving route. Utterance of the user is fed to the microphone 28 that converts voices to electrical signals to be fed to the controller 29. The user may input various commands for operating the car navigation system 20 through the microphone 28.

The controller 29 is constituted by a known microcomputer including CPU, ROM, RAM, SRAM, I/O and bus lines for inter-connecting components. Various functions of the car navigation system 20 are performed according to programs stored in the ROM and RAM. For example, a present position of the vehicle is calculated as a pair of a position and a driving direction based on signals fed from the position detector 21. The calculated present position of the vehicle is shown on the display panel 26 together with an indication of the driving direction, overlapped on the map showing a neighborhood of the present position. The controller 29 calculates an optimum driving route from the present position to a destination set by the user. The driving route is shown on the map displayed on the display panel 26, and the driving route information is outputted from the speaker 27 as voice guidance.

Now, a process for selecting items (or inputting commands) by touching the touch panel 22 will be described in detail. This process will be referred to as a touch process. Other processes such as a process of calculating a driving route, or a process of generating voice guidance will not be explained here because these are well known.

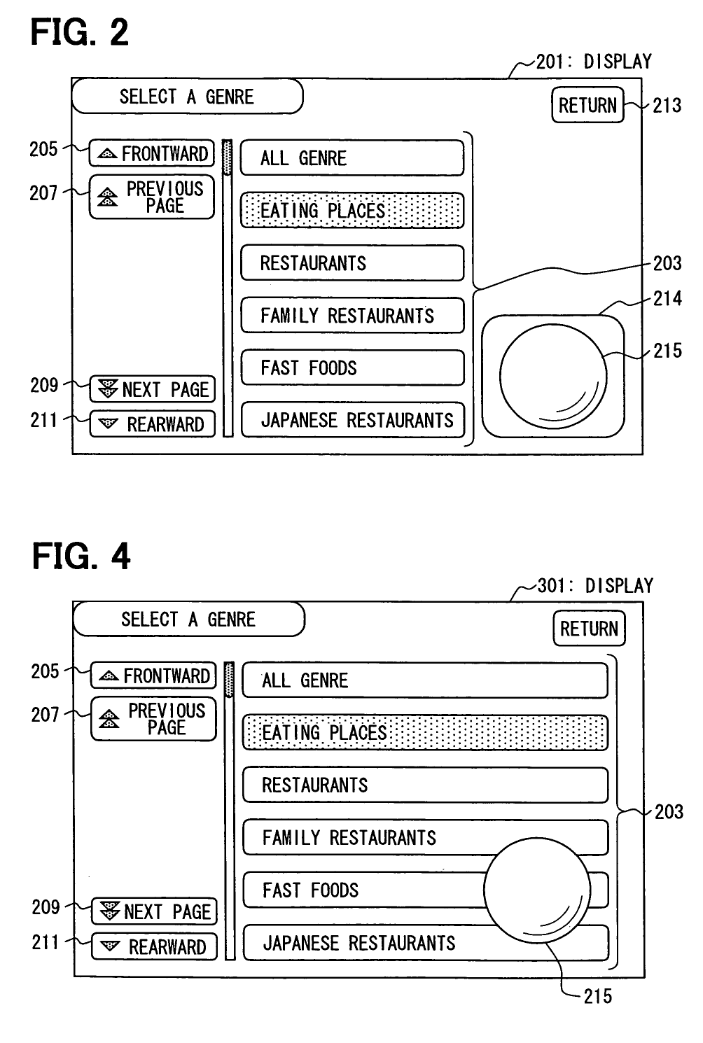

Before explaining the touch process, an example of display shown on the display panel 22 will be explained, referring to FIG. 2. The display shown in FIG. 2 is an exemplary display for selecting the destination for calculating a driving route from a present position to a destination. First, a user selects a genre that includes a desired destination by touching a button on the display. The display shown in FIG. 2 shows buttons 203 corresponding to categories (genre) from the top to the bottom. Since the display area is limited, all the categories cannot be shown in one frame. The display 201 has to be scrolled to show all the categories. The category buttons 203 are scrolled one by one by touching a frontward button 205 or a rearward button 211. When the frontward button 205 is touched, a genre (category) shown at the bottom of a previous page is shown at the top of the display 201. When the rearward button 211 is touched, a genre shown at the top of the next page is shown at the bottom of the display 201. In this manner, the categories shown on the panel can be scrolled one by one. Alternatively, the display 201 may be scrolled page by page by touching a previous page button 207 or a next page button 209.

The display 201 includes a return button 213. When the user touches the return button 213, a display previously shown on the panel (e.g., a menu display) is shown again. A ball 215 is also shown on the display 201 at a right bottom portion. This portion is an exclusive region 214 for exclusively showing the ball 215. The ball 215 rotates when the user touches it, and the genre buttons 203 are scrolled in both directions according to ways of touching the ball 215, which will be explained later in detail.

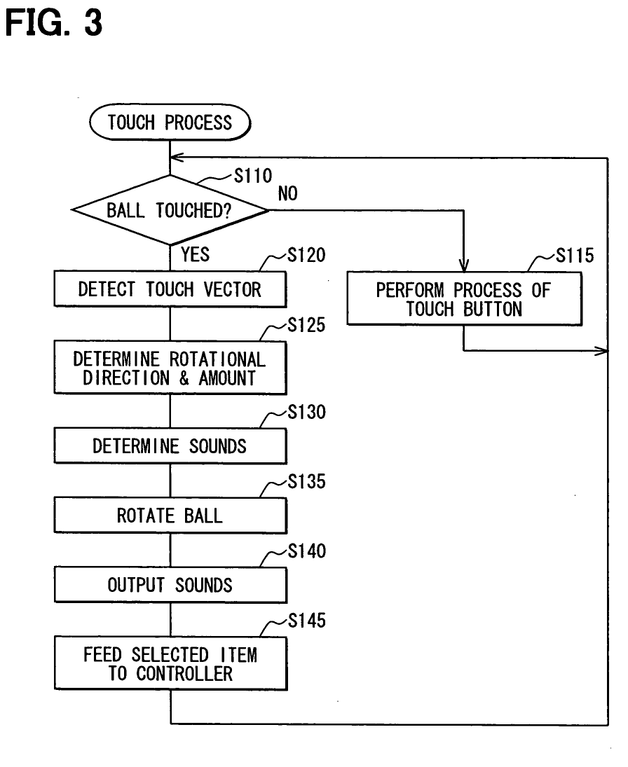

With reference to FIG. 3, the touch process performed by the controller 29 will be explained. At step S110, whether the ball 215 is touched by the user or not is detected. If the ball 215 is not touched, the process proceeds to step S115, where a process corresponding to a button actually touched is performed. For example, when one of the genre buttons 203 is touched, a genre corresponding to the touched genre button 203 is determined as a genre selected by the user. When the return button 213 is touched, the previously shown display is shown again. Then, the process returns to step S110.

If it is determined that the ball 215 is touched, the process proceeds to step S120, where a vector showing a touched path is detected. The vector consists of a touched distance (a distance from a point where the touch starts and to a point where the touch terminates) and a direction from the starting point to the last point of the touch. Then, at step S125, a rotational direction of the ball 215 and an amount of the rotation are determined according to the detected vector showing the touched path. The ball 215 is rotated by the amount and in the direction determined. However, in this particular exemplary display 201, the rotational direction of the ball 215 is limited only to a direction from the top to the bottom or vice versa. This means that only a directional component of the vector in which the rotation of the ball 215 is allowed is utilized.

Then, at step S130, a sound representing the rotation of the ball 215 is determined according to the vector corresponding to the touched path. More particularly, a kind, a volume, a duration of the sound is determined. For example, a pitch, a volume and/or a duration of the sound are set in proportion to the length of the vector. Then, at step S135, the ball 215 shown on the display 201 is rotated by the amount and in the direction determined at step S125. At step S140, the sound determined at step S130 is outputted from the speaker 27. Then, at step S145, the genre buttons 203 are scrolled according to the rotation of the ball 215, and one of the genre buttons 203 is highlighted (for example, a genre button shown in the middle is highlighted).

When the highlighted genre button 203 corresponds to a genre desired by the user, the user pushes the ball 215 to thereby select that genre. It is not necessary for the user to rotate the ball 215 in an exact direction because the genre buttons 203 are scrolled only in the vertical direction by picking up a vertical component of the vector showing the touched path. According to the rotation of the ball 215, all the genre buttons 203 can be scrolled one by one beyond the page on the display 201. When one genre is selected in this manner, places included in the selected genre are displayed. Then, the process returns to step S110.

As described above, the user can easily select an item displayed on the panel by simply touching the ball 215. The user can select a command to be inputted from among commands displayed on the panel in the similar manner. It is not necessary for the user to rotate the ball 215 in such an exact manner that is required in manipulating a scroll bar or a scroll button to select an item. It is only required for the user to touch the ball 215 to rotate it. This is especially advantageous in the navigation system because the display device has to be positioned at a restricted area and has to be operated while the car is being driven. In addition, sounds representing rotation of the ball 215 are outputted from the speaker 27. Therefore, the user can easily recognize movement of the highlighted position on the display.

The present invention is not limited to the embodiment described above, but it may be variously modified. For example, the ball 21S may continue to rotate, after the touch to the ball is terminated, in an inertia-like manner for a predetermined period or by a predetermined amount of rotation. It is also preferable to move highlighted buttons according the inertia-like rotation of the ball 215. It is possible to continuously rotate the ball 215 in an inertia-like manner after the user quickly moves the touching points. In this manner, the user can feel more reality in the scrolling operation.

Though the rotational direction of the ball 215 is limited to the vertical direction in the foregoing embodiment, the ball may be adapted to rotate freely to correspond to movement of a pointer or the like. In this case, sounds representing the rotation of the ball may be constituted by two kinds of sound elements, one corresponding to the vertical rotation and the other corresponding to the horizontal rotation. Volumes of the respective sound elements may be set in proportional to the length of the respective vectors. In this manner, the user can recognize ways of rotation of the ball 215 by means of the sounds without watching the display.

In the foregoing embodiment, the exclusive region 214 for showing the ball 215 is provided. However, this exclusive region 214 may be eliminated, and the ball 215 may be shown in an overlapped manner on the genre buttons 203, as exemplified in a display 301 shown in FIG. 4. When the ball 215 rotates, the highlighted buttons 203 also move in the same manner as in the foregoing embodiment, while the ball 215 itself stays in the same position. The space on the display 301 is effectively utilized by eliminating the excusive region 214. It is more preferable for the user to be able to select either one of the displays 201 (FIG. 2) and 301 (FIG. 4). In this case, the user may select either one by customizing the display device.

It is further preferable to make it possible to set a size of the ball 215 according to preference of the user. In this case, the ball size may be changed by inputting numerals showing the diameter of the ball, or the ball size may be changed according to ways of rotation of the ball 215. Further, positions of the ball 215 on the display may be made changeable by user's preference. In this case, the ball position may be changed by a drug-and-drop method under a position-changing mode.

The ball 215 may be displayed in an overlapped manner on a map. In this case, a scale of the displayed map may be changed by rotating the ball 215. The scale of the map is much more easily changed in this manner than by pushing buttons corresponding to respective scales. Further, the map may be scrolled according to rotation of the ball 215. Since the map can be scrolled in arbitrary directions in this manner, the user can quickly find a desired place on the map.

While the present invention has been shown and described with reference to the foregoing preferred embodiment, it will be apparent to those skilled in the art that changes in form and detail may be made therein without departing from the scope of the invention as defined in the appended claims.

What is claimed is:

1. A display device for a car navigation system comprising:
a display panel for displaying information thereon;
a touch panel for inputting commands, the touch panel being formed integrally with the display panel;
a ball displayed on the display panel; and
a controller for rotating the ball displayed on the display panel according to commands inputted from the touch panel and for performing a process based on the inputted commands.

2. The display device as in claim 1, wherein:
a pointer is displayed on the display panel; and positions of the pointer are changed according to rotation of the ball.

3. The display device as in claim 1, wherein:
the information displayed on the display panel is scrolled according to rotation of the ball.

4. The display device as in claim 1, further including map data obtaining means, wherein:
the controller displays a map on the display panel according to map data obtained by the map data obtaining means; and
a scale of the displayed map is changed according to rotation of the ball.

5. The display device as in claim 1, further including map data obtaining means, wherein:
the controller displays a map on the display panel according to map data obtained by the map data obtaining means; and
the displayed map is scrolled according to rotation of the ball.

6. The display device as in claim 1, wherein:
the ball displayed on the display panel is rotated by an amount, in a direction and at a speed, all determined according to a way of user's touch on the displayed ball.

7. The display device as in claim 6, wherein: the ball is allowed to rotate in predetermined directions.

8. The display device as in claim 6, wherein:
the ball continues to rotate in an inertia-like manner for a predetermined amount after the user's touch on the displayed ball is terminated.

9. The display device as in claim 6, further including a speaker, wherein:
the speaker outputs a sound according to a rotational speed of the ball.

10. The display device as in claim 6, further including a speaker, wherein:
the speaker outputs a sound according to a rotational direction of the ball.

11. The display device as in claim 10, wherein:
component sounds corresponding to respective rotational directions of the ball are predetermined, and a sound compounding component sounds each representing an amount of rotation in respective rotational directions is generated; and
the speaker outputs the compound sound generated.

12. The display device as in claim 1, wherein:
the ball is overlapped on the information displayed on the display panel.

13. The display device as in claim 1, wherein:
an exclusive region for exclusively displaying the ball is provided on the display panel.

14. The display device as in claim 1, wherein:
the ball is displayed on the display panel either in an exclusive region which is provided for exclusively displaying the ball or in an area other than the exclusive region according to preference of a user.

15. The display device as in claim 1, wherein:
a size of the ball displayed on the display panel is changeable according to user's touch on the touch panel.

16. The display device as in claim 1, wherein:
a position of the ball displayed on the display panel is changeable according to user's touch on the touch panel.

17. A computer program for operating the controller in a manner defined in claim 1.
